(19) United States
(12) Patent Application Publication
(10) Pub. No.: US 2017/0091851 A1
(43) Pub. Date: Mar. 30, 2017

(54) ELECTRONIC HARDWARE-BASED METHOD OF CREATING, MANAGING, AND ADHEREING TO A SAVINGS PLAN FOR A PARTICULAR ITEM OR GROUP OF ITEMS THAT IS INTEGRATED WITH A SHOPPING EXPERIENCE

(71) Applicant: AGATSU LLC, Rockville, MD (US)

(72) Inventor: Brendan Collins Snow, Rockville, MD (US)

(21) Appl. No.: 15/275,093

(22) Filed: Sep. 23, 2016

Related U.S. Application Data
(60) Provisional application No. 62/232,114, filed on Sep. 24, 2015.

(51) Int. Cl. G06Q 30/06; G06Q 20/10; G06Q 40/02

(52) U.S. Cl. CPC G06Q 30/0633; G06Q 40/02; G06Q 20/102

(57) ABSTRACT

A computer implemented system and method for a user to save for an item or group of items to be purchased later, comprising: accessing, by a user, an electronic hardware interface that includes software for creating, managing, and adhering to a savings plan to later purchase one or more items offered for sale by a retail store, to create the savings plan for the one or more items selected by the user; customizing, by the user, the savings plan by the user specifying the amount, duration, and payment interval for later being able to purchase the one or more items, and the user associating payment information of the user; activating and operating the savings plan, by the user, by making scheduled payments according to the savings plan; and completing, by the user, the savings plan, resulting in the one or more items being purchased by the user.

### RELATED APPLICATIONS

This application claims the benefit, under 35 U.S.C. §119(e), of U.S. Provisional Application No. 62/232,114, filed Sep. 24, 2015, which is incorporated herein by reference in its entirety for all purposes.

### TECHNICAL FIELD

This disclosure generally relates to online shopping, and specifically relates to savings plan for purchasing particular items that is integrated into a shopping experience.

### BACKGROUND

Since the financial crisis of 2008-2009, as many as one third of Americans report being in financial distress. The overuse of various credit products, including credit cards, has led to substantially detrimental personal financial outcomes for many people.

While the number of tools and applications designed to track expenses and savings have proliferated both on and off the internet, few have incorporated an understanding of how a user's psychology and behavior influence their savings patterns. The key is not just to provide information, or an application that makes savings automated. The necessary element is to bring an easy to use, intuitive, efficient and cost-effective savings program into pre-existing and ongoing user behavior. Applications or financial products that fail to do this suffer from a selection bias in favor of those that already have good personal financial habits, in which case, such applications or financial products are not needed.

As Richard Thaler and Cass Sunstein showed in their book Nudge: Improving Decisions about Health, Wealth and Happiness (2008), in order to procure improved outcomes in personal finance matters, it is necessary to create an improved choice architecture for users. Choice architecture is the manner in which decisions are presented to humans. By creating a choice architecture in favor of saving that is integrated into something consumers are already doing—in the case of one or more embodiments of the method and system, shopping for goods to be purchased—users do not need to drastically deviate from existing behavior, thereby increasing the odds of achieving the desired effect, namely saving money, staying out of debt, and managing personal credit and personal finances in a manner that does not result in deleterious personal financial outcomes.

### BRIEF DESCRIPTION OF THE DRAWINGS

FIG. 1 illustrates an example series of steps where a user interacts with a graphical user interface.

FIG. 2 illustrates another example series of steps where a user interacts with a graphical user interface.

FIG. 3 illustrates an example method for creating, monitoring, and adhering to a savings plan for a particular item or group of items in an application store.

FIG. 4 illustrates an example method for creating, monitoring, and adhering to a savings plan for a particular item or group of items in a merchant store.

FIG. 5 illustrates an example method for saving with credit repayment.

FIG. 6 illustrates an example computer system.

### DESCRIPTION OF EXAMPLE EMBODIMENTS

An electronic hardware-based method of creating, managing, and adhering to a savings plan for a particular item or group of items to be purchased in the future is claimed that integrates the creation of such plan directly with the shopping experience. Said purchase may occur automatically. By virtue of integrating said savings plan into the shopping experience, particularly the point of sale, and thereby substantially increasing its convenience and efficiency, said method results in substantially improved personal financial outcomes for users over prior art, by enabling the user to avoid impulse- or convenience-based borrowing which may ultimately result in financial distress in the form of non-repayment of the short-term debt funding or excessive interest charges. In one or more embodiments, said method of creating, managing, and adhering to a savings plan is run on electronic hardware such as a computer, tablet, or mobile device, as well as said computer's, tablet's, or mobile device's memory chip or memory chips, and/or a third party hardware network used to store and process information, commonly referred to as “the cloud”. Said savings plan may also be used in conjunction with short-term debt financing, such as a credit card, which may be used to purchase said particular item or group of items only after said savings plan has been successfully completed. After said purchase is completed with said short-term debt financing, such as a credit card, funds from said savings plan may be used to repay the creditor of said short-term debt financing.

One or more embodiments of the method claimed is a means of creating, monitoring, and adhering to a savings program for a particular item or group of items to be purchased in the future from a vendor or merchant. Said means are integrated into the shopping process, for example on an online store that is hosted by said vendor or merchant or by a third party on their behalf, and accessed by users via a piece of hardware with a graphical user interface, such as a computer, tablet, or mobile device. Said means of creating, managing, and adhering to said savings program may be hosted on either a user's piece of hardware's memory chip, or in a third party hardware network capable of storing and making accessible information associated with said means of creating, managing, and adhering to said savings program. Said means may be integrated at the point of sale of said shopping process, thereby creating an efficient and convenient savings alternative that is not presented in prior art.

One or more embodiments of the method or system claimed is a means of doing some or all of the above, but upon the moment of purchase, purchasing said particular item or group of items with a credit card. This procures the benefits of said credit card, including but not limited to increased security and rewards or loyalty programs, and then using said saved user funds to pay off said credit card on behalf of the user at a specified date, thereby eliminates the need for said user to payoff said credit card herself or himself, saving the user both time and the inconvenience associated with paying off said credit card, and associated risk of non-repayment and excessive interest charges, in the future.

One or more of the embodiments of the method or system claimed has, as an integral component to said method or system, a means for the retailer and/or merchant to control which items are available for purchase utilizing said payment method, on the basis of numerous controls including but not limited to those listed in the claims, which result for the retailer in improved ability to forecast demand, capture full or higher margin, and hold less inventory as a result of having improved insight into when some sales will happen by virtue of said payment method.

Particular embodiments comprise a method for a particular item or group of items to be purchased in the future, comprising, an electronic hardware interface, which enables a user to access said saving method; an electronically-readable storage medium, which stores inputs from users; a retail store, comprised of items for sale to users by a retailer or vendor; a means of selecting a particular item or group of items for which to create a savings plan; a means of selecting an option to launch an application to save for a particular item or group of items in said retail store; a means of creating a savings plan within said application for said particular item or group of items; a means of customizing said savings plan; a means of connecting the user's payment information to said application; a means of double checking or reviewing the details of said savings plan; a means of enacting or initiating said savings plan and seeing it through to completion; a savings account, into which saved funds will be deposited and stored; a means of monitoring said savings plan; a means of purchasing said particular item or group of items upon completion of said savings plan; a means of said user obtaining said purchased particular item or group of items; a means of said retail store, utilizing a hardware-based graphical user interface, to select and control which items can be paid for with said payment method on the basis of the following criteria, including but not limited to: a means of selecting which inventory is available for said payment method by inventory category, sub-category, product, SKU, or other inventory cataloging method; a means of selecting which inventory is available for said payment method on the basis of the stock level of said inventory throughout said retailer's store and warehousing system (how much of said inventory is in stock); a means of controlling start and end dates for the availability of said payment method for particular merchandise or stock; a means of limiting the total amount of time for which a given saving plan may be implemented for a particular piece or pieces of stock or merchandise, or all stock and merchandise available for sale from said retailer; whereby a person shopping at said retail store can utilize said method of saving to substantially improve personal financial outcomes by avoiding the need or impulse to borrow and the associated risk of non-repayment and associated interest charges and by providing a substantially more convenient, efficient means of saving for said item or group of items than that contemplated by prior art; and whereby said retailer, as a result of customizing said controls has meaningfully improved visibility into which items said retailer sells that customers want or need to save up money to purchase, and/or is able to uncover previously unknown demand from customers that want or need to save up money for particular items or groups of items, and/or is able to capture full or higher margin on products by virtue of said saving plans not being subject to markdowns, and/or is able to hold less inventory as a result of being able to more accurately forecast future sales as a result of customers utilizing said payment method, thereby increasing said retailer's working capital and decreasing their working capital needs.

Particular embodiments of the electronic hardware interface comprise a computer, tablet, mobile device, or other electronic hardware medium accessible to and usable by humans. Particular embodiments of the electronically-readable storage medium comprise a third party data storage hardware device, such as servers in what is commonly referred to as the “cloud”. Particular embodiments of the retail store comprise an electronic retail storefront that is available on the interne. Particular embodiments of the retail store comprise a third party vendor. Particular embodiments of the means of selecting an option to launch an application to save for a particular item or group of items in said retail store comprise an electronic button at the point of sale or checkout window. Particular embodiments of the means of creating a savings plan within said application for said particular item or group of items comprise a user may select an option for said application to automatically deduct funds from said user's source of payment information in an amount and interval predetermined by the user and deposit them into said savings account.

8. Particular embodiments of the means of customizing said savings plan include some or all of the following: the total amount to save, length of time required to meet savings goal, the amount of money to save per payment interval, the selection of a payment interval such as monthly or weekly or another payment interval. Particular embodiments of the means of connecting the user's payment information to said application comprise the user's payment information may be said user's checking account, savings account, debit card or another source of funds belonging to said user. Particular embodiments of the means of monitoring said savings plan comprise a graphical user interface to track the progress of said plan. Particular embodiments of the means of monitoring said savings plan include multiple savings plans comprised of products from one or more retailers or vendors that may be monitored. Particular embodiments of the means of enacting or initiating said savings plan and seeing it through to completion comprise an electronic payment network. Particular embodiments of the means of purchasing said particular item or group of items upon completion of said savings plan comprise an automated means of purchasing said particular item or group of items upon completion of said savings plan. Particular embodiments of the means of said user obtaining said purchased particular item or group of items comprise a delivery service to said user's designated address.

Particular embodiments comprise a method of saving for a particular item or group of items to be purchased in the future, comprising: an electronic hardware interface, which enables a user to access said saving method; an electronically-readable storage medium, which stores inputs from users; a retail store, comprised of items for sale to users by a retailer or vendor; a means of selecting a particular item or group of items for which to create a savings plan; a means of selecting an option to launch an application to save for a particular item or group of items in said retail store; a means of creating a savings plan within said application for said particular item or group of items; a means of customizing said savings plan; a means of connecting the user's payment information to said application; a means of double checking said savings plan; a means of enacting or initiating said savings plan and seeing it through to completion; a savings account, into which saved funds will be deposited and stored; a means of monitoring said savings plan; a creditor, which provides debt financing to purchase said item or group of items; a means of purchasing said particular item or group of items upon completion of said savings plan with debt financing from said creditor; a means of said user obtaining said purchased particular item or group of items; a means of paying said creditor from funds held in said savings account on behalf of a user; a means of said retail store, utilizing a hardware-based graphical user interface, to select and control which items can be paid for with said payment method on the basis of the following criteria, including but not limited to: a means of selecting which inventory is available for said payment method by inventory category, sub-category, product, SKU, or other inventory cataloging method; a means of selecting which inventory is available for said payment method on the basis of the stock level of said inventory throughout said retailer's store and warehousing system (how much of said inventory is in stock); a means of controlling start and end dates for the availability of said payment method for particular merchandise or stock; a means of limiting the total amount of time for which a given saving plan may be implemented for a particular piece or pieces of stock or merchandise, or all stock and merchandise available for sale from said retailer; whereby a person shopping at said retail store can utilize said method of saving to substantially improve personal financial outcomes by provisioning funds for a particular purchase before said purchase occurs, and doing so in a manner that is substantially more convenient and efficient than existing means of saving, by virtue of said saving or provisioning being integrated into the process of making said purchase itself. Furthermore, said provisioned funds are held on behalf of said person by said application, and ultimately used to repay said debt financing on behalf of said person at a date predetermined by said person, thereby eliminating the need, inconvenience, and hassle of paying off said debt financing at a later time, as well as eliminating the associated risk of non-repayment and excessive interest charges.

Furthermore, said retailer, as a result of customizing said controls has meaningfully improved visibility into which items said retailer sells that customers want or need to save up money to purchase, and/or is able to uncover previously unknown demand from customers that want or need to save up money for particular items or groups of items, and/or is able to capture full or higher margin on products by virtue of said saving plans not being subject to markdowns, and/or is able to hold less inventory as a result of being able to more accurately forecast future sales as a result of customers utilizing said payment method, thereby increasing said retailer's working capital and decreasing their working capital needs.

Particular embodiments of the creditor comprise a bank. Particular embodiments of the means of purchasing said particular item or group of items upon completion of said savings plan with debt financing from said creditor comprise a credit card. Particular embodiments of the means of paying said creditor from funds held in said savings account on behalf of a user eliminate the need of said user to repay said creditor as such repayment has already been completed from funds in said savings account funded by the user.

In general, prior art has focused on automation and the ability to easily manage savings programs. While these are important features of any user-friendly savings program, they do not overcome one core problem with such schemes, namely that users must first alter their behavior, in the form of seeking out and utilizing savings applications, such as those contemplated in said prior art. One or more embodiments of this method of creating, managing, and adhering to a savings program for a particular item or group of items overcomes this problem by embedding said savings program into pre-existing and ongoing user behavior, namely shopping.

Additionally, any approach that does give users complete control over their funds up until the moment of purchase will not provide users with the flexibility users have come to expect and prefer. Such an inflexible savings program is inferior to a simple savings account, which enable users to withdraw funds at any time. In order to establish an advantage over prior art, a savings program must be fully flexible, with users able to access and control their funds at all times up until the final purchase is made.

Finally, prior art has focused on the ability of users to automate savings plans wherein at the end of the saving period the user is returned the saved amount of money in the form of a reimbursement to their account or a pre-paid savings card. By contrast, the method described here, working within the pre-existing user behavior, actually completes the purchase on behalf of the user. Therefore when the user finishes the savings plan and chooses to purchase the item, the item is purchased and delivered to their designated address—rather than requiring the user to make the purchase as part of a separate transaction after receiving their funds from the saving plan agent.

“Flexible Savings System” US 20100138287 A1—This patent application describes a system of online layaway. In it, users may create a layaway plan for a particular product from a given vendor. The user can monitor the plan and change it as necessary. However, the application has two main problems. (1) Users cannot cancel their plan and withdraw funds—they are locked in once they commit to a particular vendor to buy from that vendor. As the application says, “Funds in the flexible electronic layaway account must be spent eventually on topics of purchase. The funds may be applied to different topics of purchase. Funds may also be applied to topics of purchase from different vendors if the topic of savings is not locked in. However, funds may not be withdrawn as cash to the end user or transferred to accounts accessible by the end user for withdrawal purposes.” Furthermore, the application states: “The fifth element is a means for changing target of savings. Until topic of savings is locked in, an end user is free to access the flexible electronic layaway account and change a topic of savings to another from the same vendor or a different vendor. The savings arrangements are transferred with the new topic of savings. The only restrictions are that funds in the flexible electronic layaway account must be spent eventually on topics of purchase and may be applied to different topics of purchase. Funds may not be withdrawn as cash to the end user or transferred to accounts accessible by the end user for withdrawal purposes. But an end user has restricted flexibility of change if the end user locks in a topic of savings with a vendor.” By contrast, the method claimed here enables users to cancel a savings plan and retrieve their funds in full at any time, plus a user may edit, pause, or accelerate savings plans at their discretion. It is apparent that this application does not, in fact, describe a savings system that is “flexible.”

The second problem (2) is that the application includes a cumbersome and unintuitive internet link copying step that our method eliminates. “The fourth element is a means for selecting at least one topic of savings in the account. Typically the end user first finds a topic of savings on an ecommerce site or through an ecommerce advertisement. Then the end user selects the topic of savings by copying the link into his flexible electronic layaway account. The end user may have more than one link in the account and may have different arrangements for funding each link.” By removing this step, users of our method will experience a substantial improvement in the efficiency of creating a savings plan for a particular item or group of items, thereby improving the user's ability to successfully save funds and either avoid or manage credit for that particular purchase.

“Cloud computing system and method for accumulating money” U.S. Pat. No. 8612349 B1 and “Computer implemented method for accumulating money” U.S. Pat. No. 8606713 B1. These patent grants cover a cloud computing and computer implemented system for saving “an amount of money selected by the user, an amount of money saved by not purchasing a product or service, an amount of money saved by purchasing a lower priced product or service, or an amount of money associated with a non-monetary goal.” The systems contemplated in these grants constitute general savings applications that are not tied to any particular pre-existing and ongoing user behavior, such as shopping.

“Systems and methods of targeted savings” US 20050222951 A1. This patent application establishes a means of providing a savings goal to a customer of a financial institution. “A financial institution can make offers for targeting savings deposits to its customers using a financial statement that the financial institution prepares and provides to its customers to report information related to customers' financial accounts. Such offers can be solicited or unsolicited and can include one or more targeted savings plans customized to meet customers' savings goals. The financial statement can be further used to enable customers to enroll in one or more targeted savings plans and to make savings transactions according to such plans.” Under this application, particular items may be the object of targeted savings plans, although the manner of procuring said items is not divulged, other than that it is initiated by a financial institution. By contrast, one or more embodiments of the method claimed here relies on users to initiate the savings programs.

“Method and system for impulse savings” U.S. Pat. No. 8,478,691 B2. This grant establishes a method and system of saving for a goal of one or more users by skipping other purchases of goods or services and then sending a message to one or more users that said purchase has been skipped and that funds will be allocated to a savings account to be applied toward the savings goal. This grant differs substantially from the method we claim in that users must keep track of a particular item or group of items not purchased, rather than those solely targeted for purchase. Additionally, it does not integrate a shopping experience to drive improved savings and credit management outcomes for users.

“Monitoring and representing a financial target” US 20030120572 A1. This application presents a general method of establishing a financial target for a user, including a particular item to be purchased. A user interface is recited that enables the user to monitor proximity to the goal on the basis of an inputted budget. Then, “When the user requests a financial transaction be performed, the proximity to the target after the transaction is performed is calculated and compared with the original proximity. The visual representation of the target is then modified to represent the change in proximity, and displayed to the user to show the effect of the requested transaction on the savings regime. The user is then requested to confirm or cancel the transaction.” Unlike the method claimed here, this application is aimed at comparing spending alternatives relative to a larger financial or savings goal, rather than creating, managing, and adhering to a savings plan for a particular item or group of items, which is the method claimed here.

“Method of saving for a time-delayed purchase” WO 2010011218 A1 and US20110137794 A1. These patent applications establish a means of creating a savings account tied to a savings goal, constituted of a savings category and/or a category of retailers at which to spend saved funds. Both the user as well as third parties may fund the goal as necessary. Upon completion, the savings goal is redeemed by sending the user a payment document, which may for example be a gift card at that particular retailer. A means of marketing promotions to third parties based on the savings goal is advanced. No integration with the shopping experience is recited.

“Methods and systems for providing a savings goal” U.S. Pat. No. 8,732,076 B2 and “Spending and savings secondary linked accounts” U.S. Pat. No. 7,945,512 B2. These patent grants recite a means of creating two user accounts, one primary and one secondary, with the intention of the primary account monitoring and controlling some or all aspects of spending and saving on the secondary account, such as a parent monitoring and controlling the spending of a child or an employer monitoring and controlling the spending of an employee. Savings goals can be established and managed, access can be granted or revoked for spending by the secondary account at certain vendors or merchants. However, the method we claim does not require two or more accounts, only one within the application, and furthermore is managed directly by the user, not by two users in which one is in a supervisory capacity.

While these grants and applications often include a series of prompts and a user interface to assist the user in achieving her or his financial goals, said grants and applications do not solve the problem of making the savings process convenient and efficient for the user. Users must change their behavior and adopt a highly savings-oriented mindset before such inventions will be consistently utilized by users. Adopting any new mindset, particularly a highly savings-oriented mindset is cumbersome, inconvenient, and psychologically challenging. By contrast, in the method of saving that claimed here, the process of creating a savings plan is integrated into the shopping experience, which users want to do, enjoying doing, and indeed are already doing. By only needing to push a button and follow a series of intuitive prompts, our claimed method minimizes the amount of behavior change a user must produce, and also minimizes the psychological and behavioral friction that prevents users from saving.

Furthermore, under one or more embodiments of our claimed method, we are able to eliminate altogether the need for a customer to pay off debt financing, such as that procured by a credit card, after a purchase has been made. By purchasing said particular item or group of items with a credit card after funds have been provisioned, and by virtue of said application using said funds to pay off said credit card debt at a predetermined date determined by the user, our method is able to save the user both the time, inconvenience, and worry associated with paying off credit card debt and the associated risk of non-repayment and excessive interest charges, and is able to procure for said user the benefits of credit cards, namely increased security by virtue of not putting said user's funds at risk and the rewards and loyalty benefits endemic in many credit cards.

One or more embodiments of the present invention enable users to produce superior personal financial outcomes by integrating the savings process into the shopping experience, tying said savings process to a particular item or group of items to be purchased, and/or initiating said savings process at the point of sale, rather than before, during, or independently of the shopping experience.

One or more aspects of one or more embodiments of the present invention enables users to effectively provision funds before a purchase is made, but does so in the manner laid out above (integrated with the shopping experience at point of sale), and enables the user to pay with a credit card, thereby procuring benefits of said credit card including increased security and any reward or loyalty programs endemic to said credit card, but without any of the risks associated with credit cards including non-repayment and excessive interest charges. Said risks are avoided because one or more embodiments of the present invention hold said provisioned funds on behalf of the user and, at an appropriate date, pay off said credit card debt on behalf of the user, thereby eliminating the need for and hassle to the user of paying off said credit card debt at a later date.

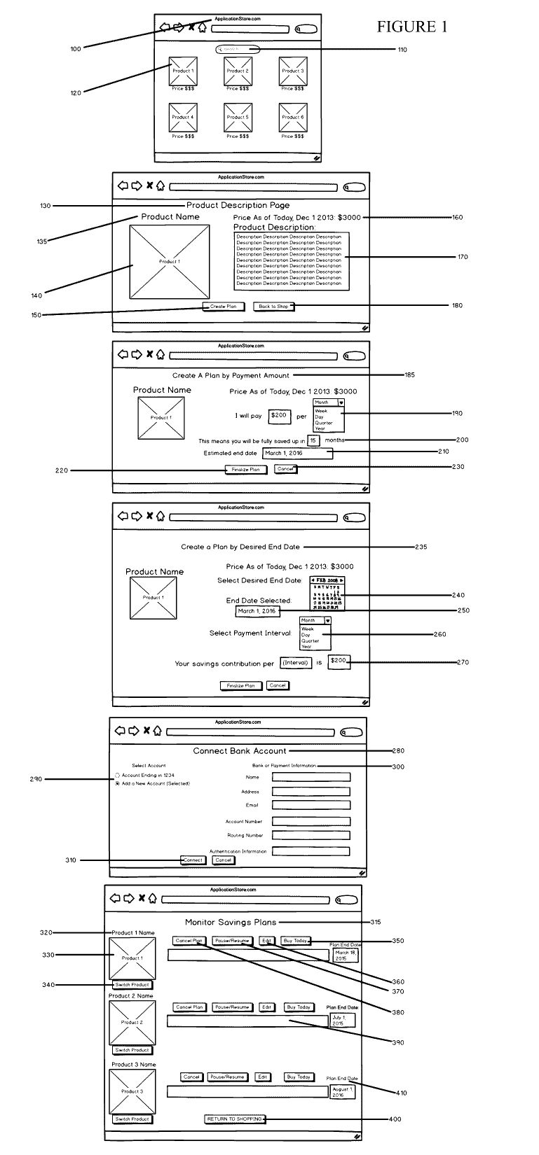

FIG. 1 illustrates an example series of steps where a user interacts with a graphical user interface, which is also referred to as Drawing 1—Application Store Embodiment.

This drawing represents the series of steps, screens, or processes of one or more embodiments wherein a user interacts with a graphical user interface on a piece of electronic hardware with a graphical user interface display, such as a computer, tablet, mobile device, or similar piece of electronic hardware.

100—“ApplicationStore.com” represents an online retail store which sells the products of another merchant, vendor, retailor, or similar or a group of merchants, vendors, retailors, or similar. In one or more embodiments, the Application Store is built and operated by the same entity that has built and operates an application which is one or more embodiments of the savings method claimed here. Operation: The user opens a web browser and navigates to the Application Store.

110—Search Bar is used to search items for sale in the Application Store. Operation: A user clicks in the Search Bar and types a search query into the field provided. After clicking “SEARCH” or pressing “ENTER” on said user's keyboard, the user's search query is fulfilled with products that meet the search terms.

120—Product is a product displayed within the store, grouped within a list of existing products. Operation: If a user clicks on a product, said user will be taken to a Product Description Page.

130—Product Description Page is a page which contains all relevant information about a particular item, such as its name, description, manufacturer and price. Operation: This figure opens automatically when a user clicks on a product. In one or more embodiments, it contains at least two buttons at the bottom, “CREATE PLAN” and “BACK TO SHOP”.

135—Product Name is a display which is populated with the name of the particular item being examined for purchase, for example “48 inch big screen TV”. Operation: This figure is static to the user, and said user only need examine the user interface to access it.

140—Product Image is a picture or image of the product being examined by the user. Operation: This figure is static to the user, and said user only need examine the user interface to access it.

150—“CREATE PLAN” Button appears at the bottom of one or more embodiments contemplated by the method claimed. It advances a user to the next stage of the savings process, namely to outline the specifics of the desired savings plan. It indicates an affirmative desire to move forward to create a savings plan for the particular item displayed on the Product Description Page. Operation: A user places his or her cursor over said button and clicks once.

160—The Product's Price indicates to the user the price for which said particular item is selling inside the Application Store. Operation: This figure is static to the user, and said user only need examine the user interface to access it.

170—Product Description describes in sentences or sentence fragments the predominant features of the particular item being examined by the user. Operation: This figure is static to the user, and said user only need examine the user interface to access it.

180—“BACK TO SHOP” Button is a button featured at the bottom of the Product Description Page in one or more embodiments. It directs the user back to the Application Store page, so said user may resume the shopping experience. Operation: A user places his or her cursor over said button and clicks once.

185—Create a Plan By Payment Amount Page is a page that is opened as a result of clicking on the “CREATE A PLAN” Button, and it specifies a means of creating a plan on the basis of the desired amount to be saved in a given interval of time in one or more embodiments. For example, a user may opt to save $300 per month. This page is presented as an alternative to the Create a Plan by Desired End Date Page. Operation: In one or more embodiments, this figure is operated by interacting with the various fields and drop down boxes, according to their purpose and usage parameters.

190—Indicate Payment Amount and Payment Interval is where the user enters the payment amount and payment interval desired to execute the savings plan. Operation: To indicate the payment amount, a user clicks within the field provided and enters a particular amount of money in a particular currency, for example $300. To indicate the payment interval, a user selects the appropriate interval from the dropdown box provided, by clicking on the arrow which directs the drop down menu to open. The user then selects the appropriate interval from the menu provided.

200—Estimation of Time to Completion by Interval Selected automatically calculates the amount of time to complete the savings goal by dividing the product price by the payment amount, resulting in a number of payment intervals until completion. For example, for a product with a price of $3000, a user might select to pay $200 per month, resulting in an estimated time to completion of 15 months. Operation: Because in one or more embodiments this figure is an automatic calculation arising from the product price and the user's inputs regarding payment amount and payment interval, the user does not need to do anything separately to see this display. It is automatically displayed on the Create a Plan by Payment Amount and Payment Interval Page.

210—Estimated End Date automatically calculates the end date of the savings plan by taking the present date and adding the estimation of time to completion by interval selected. Operation: Because in one or more embodiments this figure is an automatic calculation arising from the present date and the estimation of time to completion by interval selected, the user does not need to take any particular action to see this display. It is automatically displayed on the Create a Plan by Payment Amount and Payment Interval page.

220—“FINALIZE PLAN” Button finalizes the plan indicated by the user on the Create a Plan by Payment Interval page. Although in one or more embodiments the user may modify or cancel the plan at any time, this button provisionally locks in the details of the plan and advances the user to the next Connect Bank Account page. Operation: A user places his or her cursor over said button and clicks once.

230—“CANCEL” Button is a button that enables the user to cancel the process of creating a savings plan for a particular item. Pressing said “CANCEL” Button results in returning the user to the Product Information Page. Operation: A user places his or her cursor over said button and clicks once.

235—Create a Plan by Desired End Date Page is a page which enables a user to create a savings plan based on the desired end date, meaning the date at which said user would like the plan to finish. It is presented as an alternative to the Create a Plan by Payment Amount and Payment Interval Page. Operation: In one or more embodiments, this figure is operated by interacting with the various fields and drop down boxes, according to their purpose and usage parameters.

240—Select Desired End Date consists of an electronic calendar which a user can manipulate to select the end date at which said user would like to complete the savings plan. Operation: A user places his or her cursor over the calendar, scrolls through the calendar until the selected month and year appear displayed on said calendar, and then click once on the date said user desires to complete the savings program.

250—Display of Selected End Date automatically displays the date selected by the user in the Select Desired End Date aspect. For example, if a user selects Mar. 1, 2016 on the calendar, Mar. 1, 2016 will be displayed here in one or more embodiments. Operation: Because in one or more embodiments this figure is an automatic calculation arising from the Select Desired End Date aspect, the user does not need to take any particular action to see this display. It is automatically displayed on the Create a Plan by Desired End Date Page.

260—Select Payment Interval. In one or more embodiments, this figure is a drop down box consisting of different payment intervals that may be selected by the user. For example, a user may select to fund the plan daily, weekly, month, quarterly, or yearly. Operation: In the embodiment wherein the Select Payment Interval figure is a dropdown box, a user clicks once on the dropdown box to open a list of possible payment intervals. Said user clicks once to select the desired interval after hovering over it with said user's cursor.

270—Savings Contribution Per Interval automatically calculates and displays the amount of funding that will be contributed to the savings plan by the user per interval selected. This amount is calculated by dividing the product price by the amount of payment intervals occurring between the present date and the desired end date indicated by the user. Operation: Because in one or more embodiments this figure is an automatic calculation arising from Product Price and the number of payment intervals between the present date and the desired end date, the user does not need to take any particular action to see this display. It is automatically displayed on the Create a Plan by Desired End Date Page.

280—Connect Bank Account Page is a subsequent page to the Create Account by Payment Amount and Payment Interval Page, or the Create Account by Desired End Date Page, after a user has specified the details of the savings plan for a particular item and has clicked the “FINALIZE PLAN” Button. In one or more embodiments, the next step in the sequence is to connect the user's bank account, which is accomplished by this page. Operation: In one or more embodiments, this page automatically opens as a result of clicking the “FINALIZE PLAN” Button. The user interacts with the page by responding appropriately to the “Select Account” and “Bank or Payment Information” Fields.

290—Select Account enables a client to select a bank account from which to fund the plan. In one or more embodiments, it could be a checking account, savings account, or debit card information. Operation: The user hovers with said user's cursor over the appropriate item and selects it by clicking once.

300—Bank or Payment Information consists of a series of fields that are sufficient to collect and connect to a user's preferred payment medium to fund the savings plan, be it a checking account, savings account, or debit card information. In one or more embodiments relevant information may include the user's name, address, email address, bank name, account number, routing number, and possibly more. Operation: The user hovers over each field with said user's cursor, and clicks once to enable the user to input information into said field. Said user types the relevant information in each field until all necessary fields are complete.

310—“CONNECT” Button is a button that finalizes the process of connecting a bank account with the Application Store and savings application that enact one or more embodiments of the method claimed here. After pressing it, a user is advanced automatically to the Monitor Savings Plan Page. Operation: A user places his or her cursor over said button and clicks once.

315—Monitor Savings Plan Page is a page that serves as the main interface that enables a user to monitor new and existing savings plans. It presents options to cancel, edit, or pause savings plans, instantaneously purchase an item for which a savings plan exists, or switch products without altering a plan. Operation: A user will be automatically advanced to this page after clicking on the “CONNECT” Button. Details necessary to operate each figure contained herein are provided in subsequent figure description and operation sections.

320—Product Name for Product That Has a Savings Plan displays the product name for a product that has a savings plan. It could be a previously enacted savings plan, or the savings plan just created by the user. It is the same product name as the information displayed in the figure Product Name. Operation: This figure is automatically displayed based on the product name of the particular item selected by a user when creating the savings plan for that particular item.

330—Product Image for Product That Has a Savings Plan displays the product image for a product that has a savings plan. It could be a previously enacted savings plan, or the savings plan just created by the user. It is the same product image as that displayed in the figure Product Image. Operation: This figure is automatically displayed based on the product image of the particular item selected by a user when creating the savings plan for that particular item.

340—“SWITCH PRODUCT” Button is a button that enables a user to switch the product for which a savings plan exists without altering the details of the savings plan. In one or more embodiments, it returns the user to the Application Store to resume the shopping experience and ultimately walks said through the process of creating a savings plan, although under this use case the details of the Create a Plan by Payment Amount and Payment Interval or Create a Plan by Desired End Date, and Connect Bank Account details would already be populated with the existing savings plan details. The user would be returned to the Monitor Savings Plan Page with the new item displayed adjacent to the relevant savings plan. Operation: A user places his or her cursor over said button and clicks once.

350—“BUY TODAY” Button enables the user to immediately fund the rest of the plan from the payment source indicated on the Connect Bank Account Page and immediately finish the savings plan and purchase the item. In one or more embodiments said purchase may be automatic. Operation: A user places his or her cursor over said button and clicks once.

360—“EDIT” Button is a button that enables a user to edit the savings plan in place for a particular item. It returns the user to the Create A Plan By Payment Amount and Payment Interval Page or the Create a Plan by Desired End Date Page and walks the user through the same savings plan creation process, including the Connect Bank Account Page. The user ends on the Monitor Savings Plan Page with the new plan in place and already saved funds carried forward into the new plan. In one or more embodiments, the product is not switched with the “EDIT” Button, which edits said savings plan but not said particular item for which said savings plan exists. Operation: A user places his or her cursor over said button and clicks once.

370—“PAUSE/RESUME” Button is a button that enables the user to stop payments toward the associated savings plan without cancelling the savings plan and recalling funds into the user's bank account. When a plan has been paused, the button changes from displaying the word “PAUSE” to displaying the word “RESUME”. If a user pushes the “RESUME” button the savings plan picks up where it left off, and automatically updates the expected end date. Operation: A user places his or her cursor over said button and clicks once.

380—“CANCEL PLAN” Button is a button that enables the user to cancel the savings plan altogether and automatically refund the monies saved thus far into the user's bank account or funding source. If a user presses this button, it terminates the savings plan. Operation: A user places his or her cursor over said button and clicks once.

390—Graphical Display to Monitor Plan Progress is a graphical display on the user interface, similar to a thermometer, pie chart, or other means of graphically representing plan progress, wherein the user's progress within the predetermined savings plan is displayed in a manner consistent with the actual progress of the savings plan. For illustration purposes only, in one or more embodiments, suppose a user has saved $400 toward a $1000 object, the user interface would be 40% full and 60% empty. Operation: This figure is automatically populated on the basis of progress of a particular savings plan toward a final savings goal. As such the user does not need to take any action to access its display.

400—“RETURN TO SHOPPING” Button is a button that navigates the user away from the Monitor Savings Plan Page and returns them to the Application Store to resume the shopping experience. Operation: A user places his or her cursor over said button and clicks once.

410—Plan End Date displays the end date of the savings plan as selected by the user. It tells the user in the form of a month, day, and year, when the current savings plan will be finished. Operation: Because this figure is automatically populated based on the end date predetermined by the user during the savings plan creation process, the user does not need to take any particular action to view this information. Rather it is automatically displayed on the Monitor Savings Plan Page.

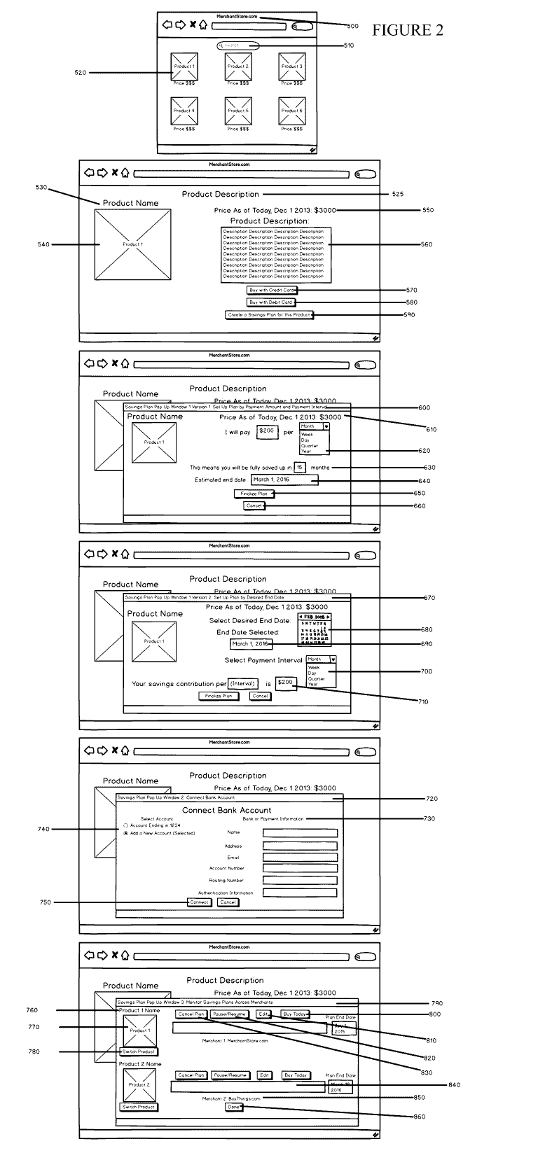

FIG. 2 illustrates another example series of steps where a user interacts with a graphical user interface, which is also referred to as Drawing 2—Merchant Store Embodiment. This figure represents the series of steps, screens, or processes of one or more embodiments wherein a user interacts with a graphical user interface on a piece of electronic hardware with a graphical user interface display, such as a computer, tablet, mobile device, or similar piece of electronic hardware.

In this and other embodiments, the method claimed here is recited as a feature hosted directly on a merchant's website, unlike in the Application Store Embodiment, in which the store is populated with products by a merchant, retailor, vendor, or similar party. In one or more embodiments, the merchant's website may be an online retail store.

500—Merchant Store consists of a Merchant's, Vendor's, Retailer's, or similar entity's store, wherein particular items are held for sale. In one or more embodiments, said Merchant Store may be an online store. Operation: In one or more embodiments, a user navigates his or her web browser to the Merchant's online store by entering the Merchant's store web address in said web browser.

510—Search Bar is used to search items for sale in the Merchant Store. Operation: A user clicks in the Search Bar and types a search query into the field provided. After clicking “SEARCH” or pressing “ENTER” on said user's keyboard, the user's search query is fulfilled with products that meet the search terms.

520—Product is a product displayed within the store, grouped within a list of existing products. Operation: If a user clicks on a product, said user will be taken to a Product Description Page.

525—Product Description Page is a page which contains all relevant information about a particular item, such as its name, description, manufacturer and price. Operation: This figure opens automatically when a user clicks on a product. In one or more embodiments, it contains at least three buttons at the bottom, “BUY WITH CREDIT CARD”, “BUY WITH DEBIT CARD”, and “CREATE A SAVINGS PLAN FOR THIS PRODUCT”

530—Product Name is a display which is populated with the name of the particular item being examined for purchase, for example “48 inch big screen TV”. Operation: This figure is static to the user, and said user only need examine the user interface to access it.

540—Product Image is a picture or image of the product being examined by the user. Operation: This figure is static to the user, and said user only need examine the user interface to access it.

550—The Product's Price indicates to the user the price for which said particular item is selling inside the Merchant Store. Operation: This figure is static to the user, and said user only need examine the user interface to access it.

560—Product Description describes in sentences or sentence fragments the predominant features of the particular item being examined by the user. Operation: This figure is static to the user, and said user only need examine the user interface to access it.

570—“BUY WITH A CREDIT CARD” Button is a button that enables the user to proceed to the Merchant's checkout page, enter credit card information, pay said Merchant, and ultimately receive the purchased item or group of items. Operation: A user places his or her cursor over said button and clicks once.

580—“BUY WITH A DEBIT CARD” Button is a button that enables the user to proceed to the Merchant's checkout page, enter debit card information, pay said Merchant, and ultimately receive the purchased item. Operation: A user places his or her cursor over said button and clicks once.

590—“CREATE A SAVINGS PLAN FOR THIS PRODUCT” Button is a button that enables the user to opt to create a savings plan using one or more embodiments of the method claimed here. Pressing this button results in the initiation of the method claimed here, including creating a savings plan, connecting a bank account, monitoring said plan, and ultimately purchasing the particular item selected. In one or more embodiments, said purchase may be automated. Operation: A user places his or her cursor over said button and clicks once.

600—Savings Plan Pop Up Window 1 Version 1: Set Up Plan by Payment Amount and Payment Interval is a pop up window that appears on the Merchant's website after pressing the “CREATE A SAVINGS PLAN FOR THIS PRODUCT” Button. It guides the user through the process of creating a savings plan for the particular item on the basis of the desired payment amount and payment interval. For example, for a $3000 item, a user may opt to save $200 per month for 15 months. Operation: In one or more embodiments, the user enters the necessary information into the relevant fields to articulate a savings plan for the particular item on the basis of the payment amount and payment interval preferred.

610—The Product's Price within Savings Plan Pop Up Window 1 Version 1: Create a Plan by Payment Amount and Payment Interval indicates to the user the price for which said particular item is selling inside the Merchant Store. It is displayed here again for the user's convenience when setting up a savings plan. Operation: This figure is static to the user, and said user only need examine the user interface to access it.

620—Indicate Payment Amount and Payment Interval is where the user enters the payment amount and payment interval desired to execute the savings plan. Operation: To indicate the payment amount, a user clicks within the field provided and enters a particular amount of money in a particular currency, for example $300. To indicate the payment interval, a user selects the appropriate interval from the dropdown box provided, by clicking on the arrow which directs the drop down menu to open. The user then selects the appropriate interval from the menu provided.

630—Estimation of Time to Completion by Interval Selected automatically calculates the amount of time to complete the savings goal by dividing the product price by the payment amount, resulting in a number of payment intervals until completion. For example, for a product with a price of $3000, a user might select to pay $200 per month, resulting in an estimated time to completion of 15 months. Operation: Because in one or more embodiments this figure is an automatic calculation arising from the product price and the user's inputs regarding payment amount and payment interval, the user does not need to do anything separately to see this display. It is automatically displayed on the Savings Plan Pop Up Window 1 Version 1: Create a Plan by Payment Amount and Payment Interval page.

640—Estimated End Date automatically calculates the end date of the savings plan by taking the present date and adding the estimation of time to completion by interval selected. Operation: Because in one or more embodiments this figure is an automatic calculation arising from the present date and the estimation of time to completion by interval selected, the user does not need to do anything separately to see this display. It is automatically displayed on Savings Plan Pop Up Window 1 Version 1: Create a Plan by Payment Amount and Payment Interval.

650—“FINALIZE PLAN” Button is a button that finalizes the plan indicated by the user on the Create a Plan by Payment Interval page. Although in one or more embodiments the user may modify or cancel the plan at any time, this button provisionally locks in the details of the plan and advances the user to the next Connect Bank Account page. Operation: A user places his or her cursor over said button and clicks once.

660—“CANCEL” Button is a button which enables the user to cancel the process of creating a savings plan for a particular item. Pressing said “CANCEL” Button results in returning the user to the Product Information Page. Operation: A user places his or her cursor over said button and clicks once.

670—Savings Plan Pop Up Window 1 Version 2: Create a Plan by Desired End Date is a pop up window that appears on the Merchant's website after pressing the “CREATE A SAVINGS PLAN FOR THIS PRODUCT” Button. It guides the user through the process of creating a savings plan for the particular item on the basis of the end date of the savings plan. A user may select to end the savings plan on a particular date, and specifies a payment interval to be applied over that period of time such as days, weeks, months, quarters, or years. The pop up window then displays the savings contribution necessary per payment interval to finish the savings plan by the desired end date. Operation: In one or more embodiments, the user enters the necessary information into the relevant fields to articulate a savings plan for the particular item on the basis of the desired end date and payment interval preferred.

680—Select Desired End Date consists of an electronic calendar which a user can use to select the end date at which said user would like to complete the savings plan. Operation: A user places his or her cursor over the calendar, scrolls through the calendar until the selected month and year appear displayed on said calendar, and then click once on the date said user desires to complete the savings program.

690—Display of Selected End Date automatically displays the date selected by the user in the Select Desired End Date aspect. For example, if a user selects Mar. 1, 2016 on the calendar, Mar. 1, 2016 will be displayed here in one or more embodiments. Operation: Because in one or more embodiments this figure is an automatic calculation arising from the Select Desired End Date aspect, the user does not need to do anything separately to see this display. It is automatically displayed on the Savings Plan Pop Up Window 1 Version 2: Create a Plan by Desired End Date Page.

700—Select Payment Interval. In one or more embodiments, this Select Payment Interval 700 is a drop down box consisting of different payment intervals that may be selected by the user. For example, a user may select to fund the plan daily, weekly, month, quarterly, or yearly. Operation: In the embodiment wherein the Select Payment Interval figure is a dropdown box, a user clicks once on the dropdown box to open a list of possible payment intervals. The user clicks once to select the desired interval after hovering over it with said user's cursor.

710—Savings Contribution Per Interval automatically calculates and displays the amount of funding that will be contributed to the savings plan by the user per interval selected. This amount is calculated by dividing the product price by the amount of payment intervals occurring between the present date and the desired end date indicated by the user. Operation: Because in one or more embodiments this figure is an automatic calculation arising from Product Price and the number of payment intervals between the present date and the desired end date, the user does not need to do anything separately to see this display. It is automatically displayed on the Create a Plan by Desired End Date Page.

720—Savings Plan Pop Up Window 2: Connect Bank Account is the next in the series of pop up windows that appears to guide the user through the savings plan creation process after pressing the “CREATE A SAVINGS PLAN FOR THIS PRODUCT” Button. It walks the user through the process of selecting and entering bank or payment information to be used to fund the savings plan. Operation: In one or more embodiments, the user enters the necessary information into the relevant fields to collect the requisite bank or payment information to successfully fund the savings plan according to the specified plan details.

730—Bank or Payment Information comprises a series of field that are sufficient to collect and connect to a user's preferred payment medium to fund the savings plan, be it a checking account, savings account, or debit card information. In one or more embodiments relevant information may include the user's name, address, email address, bank name, account number, routing number, and possibly more. Operation: The user hovers over each field with his or her cursor, and clicks once to enable the user to input information into said field. The user types the relevant information in each field until all necessary fields are complete.

740—Select Account enables a client to select a bank account from which to fund the plan. In one or more embodiments, it could be a checking account, savings account, or debit card information. Operation: The user hovers over the appropriate item and selects it by clicking once.

750—“CONNECT” Button is a button that finalizes the process of connecting a bank account with the Merchant Store and savings application that enact one or more embodiments of the method claimed here. After pressing it, a user is advanced automatically to the Savings Plan Pop Up Window 3: Monitor Savings Plans Across Merchants Page. Operation: A user places his or her cursor over said button and clicks once.

760—Product Name for Product That Has a Savings Plan displays the product name for a product that has a savings plan. It could be a previously enacted savings plan, or the savings plan just created by the user. It is the same product name as the information displayed in the figure Product Name. Operation: This figure is automatically displayed based on the product name of the particular item selected by a user when creating the savings plan for that particular item.

770—Product Image for Product That Has a Savings Plan displays the product image for a product that has a savings plan. It could be a previously enacted savings plan, or the savings plan just created by the user. It is the same product image as that displayed in the figure Product Image. Operation: This figure is automatically displayed based on the product image of the particular item selected by a user when creating the savings plan for that particular item.

780—“SWITCH PRODUCT” Button is a button that enables a user to switch the product being saved for without altering the details of the savings plan. In one or more embodiments, it returns the user to the Merchant Store to resume the shopping experience and ultimately walk them through the process of creating a savings plan, although under this use case the details of the Savings Plan Pop Up Window 1 Version 1: Create a Plan by Payment Amount and Payment Interval or Savings Plan Pop Up Window 1 Version 2: Create a Plan by Desired End Date, and Savings Plan Pop Up Window 2: Connect Bank Account details would already be populated with the existing savings plan details. The user would be returned to the Savings Plan Pop Up Window 3: Monitor Savings Plans Across Merchants Page with the new item displayed adjacent to the relevant savings plan. Operation: A user places his or her cursor over said button and clicks once.

790—Savings Plan Pop Up Window 3: Monitor Savings Plans Across Merchants Page is the final pop up window in the series that enables the user to see both the recently created savings plan for the particular item selected as well as other savings plans for other items. On this page, the user also has management control over each of the plans through a series of buttons detailed in further sections. Operation: The page opens automatically as a result of pressing the “CONNECT” Button. All of the relevant information is displayed for the user to see existing savings plans and manage them accordingly, including the savings plan just created.

800—“BUY TODAY” Button enables the user to immediately fund the rest of the plan from the payment source indicated on the Savings Plan Pop Up Window 2: Connect Bank Account Page and immediately finish the savings plan and purchase the item. In one or more embodiments said purchase may be automatic. Operation: A user places his or her cursor over said button and clicks once.

810—“EDIT” Button is a button that enables a user to edit the savings plan in place for a particular item. It returns the user to the Savings Plan Pop Up Window 1 Version 1: Create A Plan By Payment Amount and Payment Interval Page or the Savings Plan Pop Up Window 1 Version 2: Create a Plan by Desired End Date Page and walks the user through the same savings plan creation process, including the Savings Plan Pop Up Window 2: Connect Bank Account Page. The user ends on the Savings Plan Pop Up Window 3: Monitor Savings Plans Across Merchants Page with the new plan in place and already saved funds carried forward into the new plan. In one or more embodiments, the product is not switched with the “EDIT” Button, a task that is accomplished with the “SWITCH PRODUCTS” Button. Operation: A user places his or her cursor over said button and clicks once.

820—“PAUSE/RESUME” Button is a button that enables the user to stop payments toward the associated savings plan without cancelling the savings plan and recalling funds into the user's bank account. When a plan has been paused, the button changes from displaying the word “PAUSE” to displaying the word “RESUME”. If a user pushes the “RESUME” button the savings plan picks up where it left off, and automatically updates the expected end date. Operation: A user places his or her cursor over said button and clicks once.

830—“CANCEL PLAN” Button is a button that enables the user to cancel the savings plan altogether and automatically refund the monies saved thus far into the user's bank account or funding source. If a user presses this button, it terminates the savings plan. Operation: A user places his or her cursor over said button and clicks once.

840—Graphical Display to Monitor Plan Progress is a graphical display on the user interface, similar to a thermometer, pie chart, or other means of graphically representing plan progress, wherein the user's progress within the predetermined savings plan is displayed in a manner consistent with the actual progress of the savings plan. For illustration purposes only, in one or more embodiments, suppose a user has saved $400 toward a $1000 object, the user interface would be 40% full and 60% empty. Operation: This figure is automatically populated on the basis of progress of a particular savings plan toward a final savings goal. As such the user does not need to take any action to access its display.

850—Merchant Name for Particular Savings Plan displays the name of the particular merchant, vendor, retailer, or similar entity which sells the product for which the user has created a savings plan. Operation: Because this figure automatically appears on the Savings Plan Pop Up Window 3: Monitor Savings Plans page, a user does not need to take any particular action to access it.

860—“DONE” Button is a button that closes the pop up window associated with creating a savings plan for a particular item, and returns the user to the Merchant Store to resume the shopping experience. Operation: A user places his or her cursor over said button and clicks once.

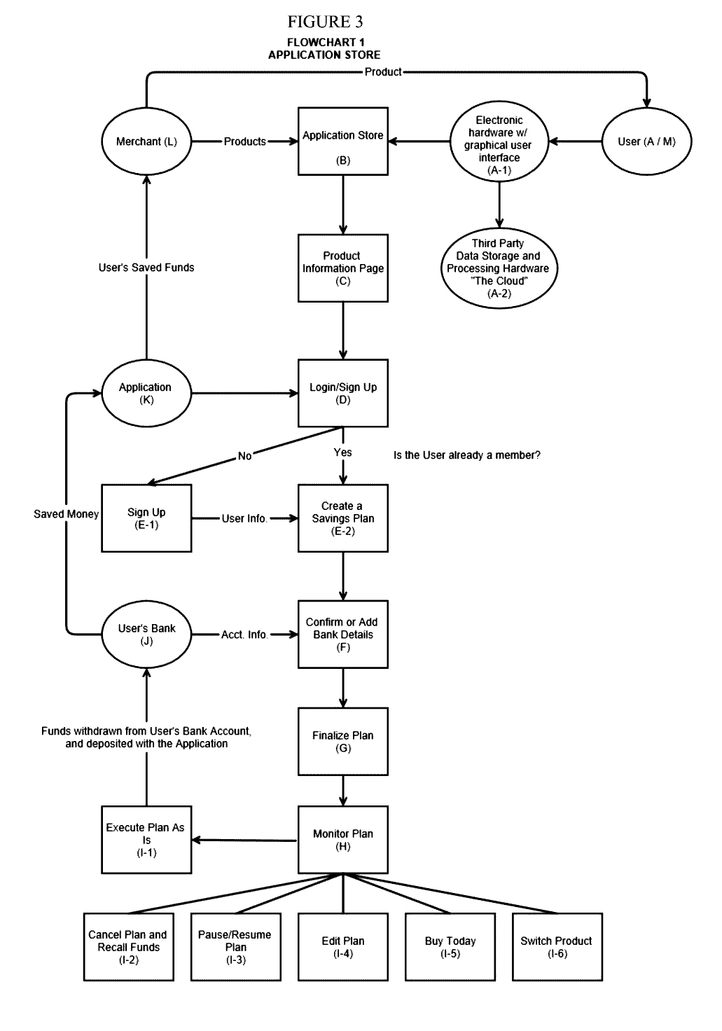

FIG. 3 illustrates an example method for creating, monitoring, and adhering to a savings plan for a particular item or group of items in an application store, which is also referred to as Flowchart 1—Application Store.

User (A/M) represents the human who initiates and uses the method of creating, monitoring, and adhering to savings plans for a particular item or group of items, as described in the claims.

A-1—Electronic hardware with graphical user interface represents the electronic hardware with a graphical user interface that a user will manipulate to access and interface with the method claimed here wherein said user can create, manage, and adhere to a savings plan for a particular item or group of items. Said electronic hardware with a graphical user interface could be a computer, tablet, mobile device, or other electronic hardware with a graphical user interface. In one or more embodiments, the information associated with the method of creating, managing, and adhering to savings plans claimed here may be hosted on the user's electronic hardware with a graphical user interface, by means of the memory-chip enabled storage and data processing capacity housed in most such hardware devices.

A-2—Third Party Data Storage and Processing Hardware; “The Cloud” represents the third party hardware, which is linked to a user's electronic hardware with a graphical user interface by the internet, which contains data storage and processing capacity, commonly referred to as “The Cloud”. In one or more embodiments, some or all of the information stored and processed in the method claimed here may be stored on said third party data storage and processing hardware, also known as “The Cloud.”

B—Application Store represents the store, which in one or more embodiments is an online store, wherein a user initiates the shopping experience. The Application Store hosts and is integrated with the Application for the sole intent of implementing the method of creating, managing, and adhering to the savings plan or savings plans create by the user.

C—Product Information Page is the page that appears to the user to give more information about a particular item for sale in the Application Store under consideration for the creation of savings plan, with the intent to purchase it later on.

D—Login/Sign Up is a page that appears to the user to enter credentials necessary to access said user's personal account and corresponding information regarding existing savings plans, including particular items for which a savings plan exists and payment information.

E-1—Sign Up is a page which appears to the user if said user has yet to create an account to allow access to said user to the application that enables said user to implement one or more embodiments of the method of creating, monitoring, and adhering to savings plans as recited in the claims.

E-2—Create a Savings Plan is a page that appears to the user which enables said user to enter the particular details necessary to create a savings plan for the particular item or group of items selected, which in one or more embodiments may include the payment amount, payment interval, and desired end date.

F—Confirm or Add Bank Account Details is a page that appears to the user which enables said user to input information regarding the source of funds which will, in one or more embodiments, be used to fund savings plans.

G—Finalize Plan is a step in the savings plan creation process, wherein, in one or more embodiments, a user confirms the details of said savings plan and gives said user the option to alter said savings plan if said user so desires. Alteration of said savings plan returns said user to Create a Savings Plan and walks said user through the Confirm or Add Bank Account Details step until said user has no more alterations to make to said savings plan. Once said user is satisfied with said savings plan, said user affirms said savings plan at this step and proceeds to the Monitor Plans Page.

H—Monitor Plans is a page that appears to the user which provides the user with all the relevant details of each and every savings plan the user currently has under way. In one or more embodiments, such details include the product name, the product image, a thermometer-like, pie-chart like, or similar graphical display for each particular item or group of items for which a savings plan exists, the end date of each savings plan in its current form, as well as the following buttons for each savings plan: Cancel Plan, Pause Plan, Edit Plan, Buy Today, and Switch Product.

I-1—Execute Plan As Is is the action path in which a savings plan is implemented without editing, until the amount of funds saved under said savings plan equals the price of the item to be purchased. In one or more embodiments, the particular item or group of items to be purchased is automatically purchased on behalf of the user.

I-2—Cancel Plan and Recall Funds is a button that appears on the Monitor Plans Page that enables a user to cancel the savings plan for a particular item or group of items and recall or refund funds back to the corresponding source of said funds, such said user's bank account.

I-3—Pause/Resume Plan is a button that appears on the Monitor Plans Page that enables a user to temporarily cease, and later resume, payments to the savings plan for a particular item or group of items. In one or more embodiments said Pause/Resume Plan button, does not result in a recall or refunding of funds in said savings plan, but rather only results in payments ceasing to said savings plan. A user presses said button once to pause or temporarily cease payments to said savings plan, and a second time to resume or reinitiate payments to said savings plan. Upon re-initiation of said savings plan, end date is automatically updated for the user such that savings plan picks up where said savings plan previously left off, on the basis of an identical payment amount, payment interval and/or remaining time to completion.

I-4—Edit Plan is a button that appears on the Monitor Plans Page that enables a user to change the particular details of a savings plan for a particular item or group of items. It does not result in changing out the current item or group of items for which a savings plan has been enacted for a new item or group of items under the same plan, as this aspect is covered by the Switch Product Button. Rather the Edit Plan button brings the user back to the Create a Plan Page and enables the user to edit particular aspects of the plan such as the payment amount, the payment interval, and the desired end date.

I-5—Buy Today is a button that appears on the Monitor Plans Page that enables a user to withdraw the amount of funds that are yet to be saved under a particular savings plan for a particular item or group of items and to proceed to purchase said item immediately. Under one or more embodiments, said purchase may occur automatically.

I-6—Switch Product is a button that appears on the Monitor Plans Page that enables a user to return to the Application Store, resume the shopping experience, and swap out the existing particular item or group of items for a new item or group of items for which a savings plan is implemented. In one or more embodiments, such a process happens without going through the process of creating a savings plan, connecting a bank account or source of funds, and any other relevant steps to create a savings plan. In one or more embodiments, after selecting a new item or group of items, the user is returned to the Monitor Plans Page, with the new item or group of items displayed in place of the previously existing product name and product image.

J—User's Bank represents the bank account or source of funds controlled solely by the user, for which the user provides information to the application to access said bank account or source of funds to fund savings plans as directed by the user.

K—Application represents any and all back end systems and hardware, including in one or more embodiments one or more bank accounts provided by the Application Store to hold the funds on the user's behalf while savings plans are being implemented according to the User's commands.

L—Merchant represents the merchant, vendor, retailer, or a similar entity that provides the products that are for sale in the Application Store. The application will ultimately use funds from user-created savings plans to purchase the particular items or group of items for which savings plans were created by the user. In one or more embodiments, said merchant will provide product information such as the product name, product image, product description, price, and other such information relevant to the user to make an informed decision about creating a savings plan for said product or a group of products with the intent to ultimately purchase said product or group of products.

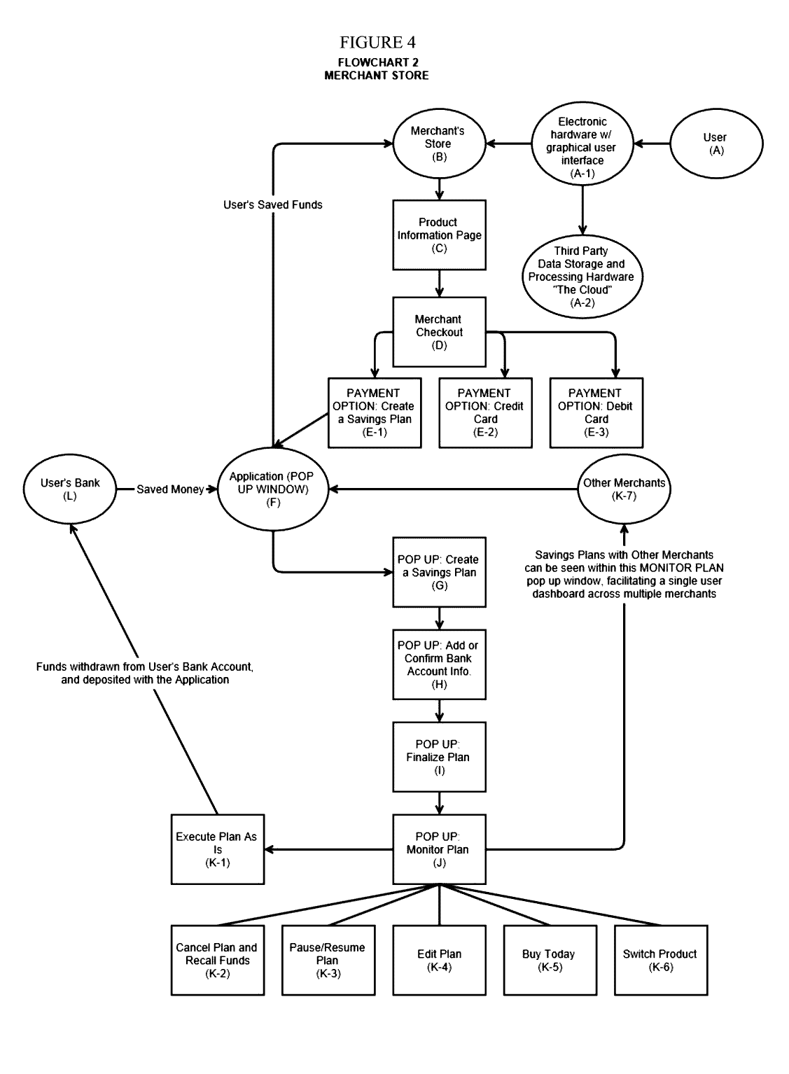

FIG. 4 illustrates an example method for creating, monitoring, and adhering to a savings plan for a particular item or group of items in a merchant store, which is also referred to as Flowchart 2—Merchant Store.

A—User represents the human who initiates and uses the method of creating, monitoring, and adhering to savings plans for a particular item or group of items, as described in the claims.

A-1—Electronic hardware with graphical user interface represents the electronic hardware with a graphical user interface that a user will manipulate to access and interface with the method claimed here wherein said user can create, manage, and adhere to a savings plan for a particular item or group of items. Said electronic hardware with a graphical user interface could be a computer, tablet, mobile device, or other electronic hardware with a graphical user interface. In one or more embodiments, the information associated with the method of creating, managing, and adhering to savings plans claimed here may be hosted on the user's electronic hardware with a graphical user interface, by means of the memory-chip enabled storage and data processing capacity housed in most such hardware devices.

A-2—Third Party Data Storage and Processing Hardware; “The Cloud” represents the third party hardware, which is linked to a user's electronic hardware with a graphical user interface by the internet, which contains data storage and processing capacity, commonly referred to as “The Cloud”. In one or more embodiments, some or all of the information stored and processed in the method claimed here may be stored on said third party data storage and processing hardware, also known as “The Cloud.”

B—Merchant's Store represents the store, which in one or more embodiments is an online store, wherein a user initiates the shopping experience. The Merchant Store is the proprietary storefront of a merchant, vendor, retailor, or similar entity that hosts and is integrated with the Application, which, in one or more embodiments, takes the form of a button presented to the user as an option at checkout. Clicking on said button enables said user to implement the method of creating, managing, and adhering to the savings plan or savings plans create by the user.

C—Product Information Page is the page that appears to the user to give more information about a particular item for sale in the Merchant Store under consideration for the creation of savings plan, with the intent to purchase it later on.

D—Merchant Checkout is the page or process on the Merchant Store that initiates the process of purchasing the particular item or group of items observed on the Product Information Page or Product Information Pages.

E-1—PAYMENT OPTION: Create a Savings Plan is a button that appears on the Merchant Checkout page or during the Merchant Checkout process that opens the series of pop up windows which take a user through the process of creating a savings plan, connecting a bank account or payment information, monitoring, managing, and ultimately implementing said savings plan. In one or more embodiments it is presented as a button directly on the Merchant Checkout page.

E-2—PAYMENT OPTION: Credit Card represents the process or feature on the Merchant Checkout page that results in a user paying for the particular item or group of items with a credit card.

E-3—PAYMENT OPTION: Debit Card represents the process or feature on the Merchant Checkout page that results in a user paying for the particular item or group of items with a debit card.

F—Application: POP UP WINDOW represents the process or series of pages that opens as a pop up window over the Merchant Store's website after the Create A Savings Plan option has been selected by the user. In one or more embodiments it includes the series of pop up windows which take the user through the process of creating, managing, and adhering to a savings plan per the method claimed. In one or more applications it includes a bank account which holds the funds initiated under the savings plan and stored on behalf of the user according to said user's commands. In one or more embodiments an automatic purchase may be performed on behalf of the user.

G—POP UP: Create A Savings Plan is a pop up window that appears to the user which enables said user to input information regarding the source of funds which will, in one or more embodiments, be used to fund savings plans.

H—POP UP: Add or Confirm Bank Account Information is a pop up window that appears to the user which enables said user to input information regarding the source of funds which will, in one or more embodiments, be used to fund savings plans.

I—POP UP: Finalize Plan is a step in the savings plan creation process, wherein, in one or more embodiments, a user confirms the details of said savings plan and gives said user the option to alter said savings plan if said user so desires. Alteration of said savings plan returns said user to Create a Savings Plan and walks said user through the Confirm or Add Bank Account Details step until said user has no more alterations to make to said savings plan. Once said user is satisfied with said savings plan, said user affirms said savings plan at this step and proceeds to the Monitor Plans pop up window.

J—POP UP: Monitor Plan is a pop up window that appears to the user which provides the user with all the relevant details of each and every savings plan the user currently has under way. In one or more embodiments, such details include the product name, the product image, a thermometer-like, pie chart like, or similar graphical display for each particular item or group of items for which a savings plan exists, the end date of each savings plan in its current form, as well as the following buttons for each savings plan: Cancel Plan, Pause Plan, Edit Plan, Buy Today, and Switch Product.

K-1—Execute Plan As Is is the action path in which a savings plan is implemented without editing, until the amount of funds saved under said savings plan equals the price of the item to be purchased. In one or more embodiments, the particular item or group of items to be purchased is automatically purchased on behalf of the user.

K-2—Cancel Plan and Recall Funds is a button that appears on the Monitor Plans pop up window that enables a user to cancel the savings plan for a particular item or group of items and recall or refund funds back to the corresponding source of said funds, such said user's bank account.

K-3—Pause/Resume Plan is a button that appears on the Monitor Plans pop up window that enables a user to temporarily cease, and later resume, payments to the savings plan for a particular item or group of items. In one or more embodiments said Pause/Resume Plan button, does not result in a recall or refunding of funds in said savings plan, but rather only results in payments ceasing to said savings plan. A user presses said button once to pause or temporarily cease payments to said savings plan, and a second time to resume or reinitiate payments to said savings plan. Upon reinitiation of said savings plan, end date is automatically updated for the user such that savings plan picks up where said savings plan previously left off, on the basis of an identical payment amount, payment interval and/or remaining time to completion.

K-4—Edit Plan is a button that appears on the Monitor Plans pop up window that enables a user to change the particular details of a savings plan for a particular item or group of items. It does not result in changing out current item or group of items for which a savings plan has been enacted for a new item or group of items under the same plan, as this aspect is covered by the Switch Product Button. Rather the Edit Plan button brings the user back to the Create a Plan pop up window and enables the user to edit particular aspects of the plan such as the payment amount, the payment interval, and the desired end date.

K-5—Buy Today is a button that appears on the Monitor Plans pop up window that enables a user to withdraw the amount of funds that are yet to be saved under a particular savings plan for a particular item or group of items and to proceed to purchase said item immediately. Under one or more embodiments, said purchase may occur automatically.

K-6—Switch Product is a button that appears on the Monitor Plans pop up window that enables a user to return to the Merchant Store, resume the shopping experience, and swap out the existing particular item or group of items for a new item or group of items for which a savings plan is implemented. In one or more embodiments, such a process happens without going through the process of creating a savings plan, connecting a bank account or source of funds, and any other relevant steps to create a savings plan. In one or more embodiments, after selecting a new item or group of items, the user is returned to the Monitor Plans pop up window, with the new item or group of items displayed in place of the previously existing product name and product image.

K-7—Other Merchants represents other merchants than the specific merchant the website of which hosts the Create a Savings Plan button and subsequent process and/or series of prompt that constitute one embodiment of the savings plan creation method claimed. These other merchants may or may not also have an identical button that initiates an identical savings plan creation process on their websites for their particular products. In one or more embodiments, under the Monitor Plans pop up window, the user can see savings plans with other particular items or groups of items from one or more other merchants.

L—User's Bank represents the bank account or source of funds controlled solely by the user, for which the user provides information to the application to access said bank account or source of funds to fund savings plans as directed by the user.

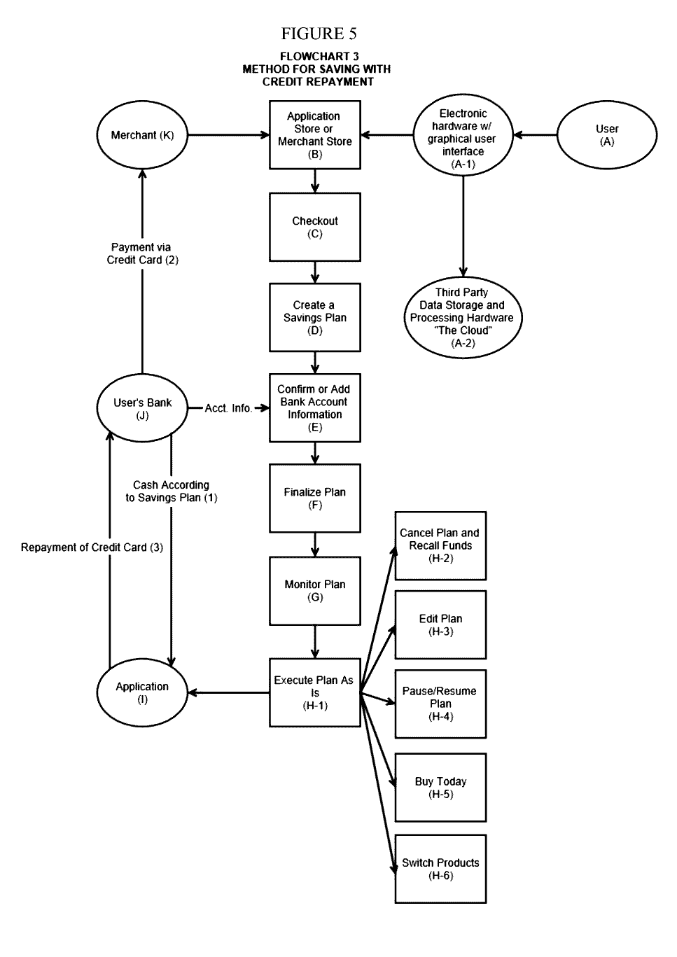

FIG. 5 illustrates an example method for saving with credit repayment, which is also referred to as Flowchart 3—Method for Saving with Credit Repayment.

A—User represents the human who initiates and uses the method of creating, monitoring, and adhering to savings plans for a particular item or group of items, as described in the claims.

A-1—Electronic hardware with graphical user interface represents the electronic hardware with a graphical user interface that a user will manipulate to access and interface with the method claimed here wherein said user can create, manage, and adhere to a savings plan for a particular item or group of items. Said electronic hardware with a graphical user interface could be a computer, tablet, mobile device, or other electronic hardware with a graphical user interface. In one or more embodiments, the information associated with the method of creating, managing, and adhering to savings plans claimed here may be hosted on the user's electronic hardware with a graphical user interface, by means of the memory-chip enabled storage and data processing capacity housed in most such hardware devices.

A-2—Third Party Data Storage and Processing Hardware; “The Cloud” represents the third party hardware, which is linked to a user's electronic hardware with a graphical user interface by the internet, which contains data storage and processing capacity, commonly referred to as “The Cloud”. In one or more embodiments, some or all of the information stored and processed in the method claimed here may be stored on said third party data storage and processing hardware, also known as “The Cloud.”

B—Application Store or Merchant Store represents either the Application Store as described in Flowchart 1 or the Merchant Store as described in Flowchart 2.

C—Checkout represents the process, hosted on either the Application Store or Merchant Store, that is initiated and completed when a user purchases a particular item or group of items from the Application Store or the Merchant Store.

D—Create a Savings Plan is a page or pop up window that appears to the user which enables said user to enter the particular details necessary to create a savings plan for the particular item or group of items selected, which in one or more embodiments may include the payment amount, payment interval, and desired end date.

E—Confirm or Add Bank Account Information is a page or pop up window that appears to the user which enables said user to input information regarding the source of funds which will, in one or more embodiments, be used to fund savings plans.

F—Finalize Plan is a step in the savings plan creation process, wherein, in one or more embodiments, a user confirms the details of said savings plan and gives said user the option to alter said savings plan if said user so desires. Alteration of said savings plan returns said user to Create a Savings Plan and walks said user through the Confirm or Add Bank Account Details step until said user has no more alterations to make to said savings plan. Once said user is satisfied with said savings plan, said user affirms said savings plan at this step and proceeds to the Monitor Plans page or pop up window.

G—Monitor Plan is a page or pop up window that appears to the user which provides the user with all the relevant details of each and every savings plan the user currently has under way. In one or more embodiments, such details include the product name, the product image, a thermometer-like, pie chart like, or similar graphical display for each particular item or group of items for which a savings plan exists, the end date of each savings plan in its current form, as well as the following buttons for each savings plan: Cancel Plan, Pause Plan, Edit Plan, Buy Today, and Switch Product.

H-1—Execute Plan As Is is the action path in which a savings plan is implemented without editing, until the amount of funds saved under said savings plan equals the price of the item to be purchased. In one or more embodiments, the particular item or group of items to be purchased is automatically purchased on behalf of the user.

H-2—Cancel Plan and Recall Funds is a button that appears on the Monitor Plans page or pop up window that enables a user to cancel the savings plan for a particular item or group of items and recall or refund funds back to the corresponding source of said funds, such said user's bank account.

H-3—Edit Plan is a button that appears on the Monitor Plans page or pop up window that enables a user to change the particular details of a savings plan for a particular item or group of items. It does not result in changing out current item or group of items for which a savings plan has been enacted for a new item or group of items under the same plan, as this aspect is covered by the Switch Product Button. Rather the Edit Plan button brings the user back to the Create a Plan page or pop up window and enables the user to edit particular aspects of the plan such as the payment amount, the payment interval, and the desired end date.

H-4—Pause/Resume Plan is a button that appears on the Monitor Plans page or pop up window that enables a user to temporarily cease, and later resume, payments to the savings plan for a particular item or group of items. In one or more embodiments said Pause/Resume Plan button, does not result in a recall or refunding of funds in said savings plan, but rather only results in payments ceasing to said savings plan. A user presses said button once to pause or temporarily cease payments to said savings plan, and a second time to resume or reinitiate payments to said savings plan. Upon reinitiation of said savings plan, end date is automatically updated for the user such that savings plan picks up where said savings plan previously left off, on the basis of an identical payment amount, payment interval and/or remaining time to completion.

H-5—Buy Today is a button that appears on the Monitor Plans page or pop up window that enables a user to withdraw the amount of funds that are yet to be saved under a particular savings plan for a particular item or group of items and to proceed to purchase said item immediately. Under one or more embodiments, said purchase may occur automatically.

H-6—Switch Products is a button that appears on the Monitor Plans page or pop up window that enables a user to return to the Merchant or Application Store, resume the shopping experience, and swap out the existing particular item or group of items for a new item or group of items for which a savings plan is implemented. In one or more embodiments, such a process happens without going through the process of creating a savings plan, connecting a bank account or source of funds, and any other relevant steps to create a savings plan. In one or more embodiments, after selecting a new item or group of items, the user is returned to the Monitor Plans page or pop up window, with the new item or group of items displayed in place of the previously existing product name and product image.

I—Application represents any and all back end systems and hardware, including in one or more embodiments one or more bank accounts provided to the user to hold the funds on the user's behalf while savings plans are being implemented according to the user's commands.

J—User's Bank represents the bank account or source of funds controlled solely by the user, for which the user provides information to the application to access said bank account or source of funds to fund savings plans as directed by the user.

K—Merchant represents the merchant, vendor, retailer, or a similar entity that provides the products that are for sale in the Application Store or Merchant Store. The application will ultimately use funds from user-created savings plans to purchase the particular items or group of items for which savings plans were created by the user. In one or more embodiments, said merchant will provide product information such as the product name, product image, product description, price, and other such information relevant to the user to make an informed decision about creating a savings plan for said product or a group of products with the intent to ultimately purchase said product or group of products.

In one or more embodiments of the electronic hardware-enabled method of creating, managing, and adhering to a savings plan claimed here present substantial advantages over prior art, including but not limited to a more convenient, efficient, and psychologically and behaviorally conducive means of seeing said savings plans through to completion, resulting for the user in improved personal financial outcomes. These outcomes can include, but are not limited to, the risk of non-repayment of impulsively made borrowings, such as from a credit card, as well as the associated risk of excessive interest charges stemming from said borrowing. Furthermore, in the event of serious personal financial difficulties, users will have a pool of funds available, in the form of said savings plans, to draw from to continue to meet their day to day needs such as purchasing gasoline to drive to work or food to feed said user and said user's family. To the extent that a user uses said method, said user has built a layer of security into said user's personal financial situation, in the form of the funds used for savings plans, and has done so in a manner that is psychologically easy, efficient, and behaviorally convenient.

Furthermore, in one or more embodiments of the electronic-hardware enabled method of creating managing, and adhering to a savings plan can include a means of provisioning funds for a particular item or group of items, paying for said items or group of items with debt financing, such as a credit card, using the provisioned funds, held on behalf of the user by the application, and to pay off said debt financing on behalf of said user at a date predetermined by said user, thereby eliminating the need and associated inconvenience and burden to said user of having to pay off said debt funding, such as credit card debt, thereby eliminating the risk of non-repayment to said user and the associated risk of excessive interest charges.

Furthermore, the reader will see that by virtue of the retailer utilizing said payment method, said retailer also benefits from meaningfully improved financial and operating metrics, including but not limited to an improved ability to forecast demand for some products, the ability to capture full or higher margin, the ability to hold less inventory, and others.

While the above descriptions contain many specificities, these should not be construed as limitations on the scope, but rather as an exemplification of one or more embodiments thereof. Many other variations are possible, only few of which are detailed below.

In one or more embodiments, a user may be able leverage said method to create, manage, and adhere to a savings program for a particular item or group of items in a physical retail context, in which a user would select a particular item or group of items for which to create a savings plan, download images of said item(s) from said retailer's website to said user's computer, tablet, mobile device, or other hardware with a graphical user interface, or in the event that said retailer has no website, take a photograph with said user's tablet, mobile device, or other hardware with a graphical user interface, and follow at least one of the steps described above to create a savings plan and see it through to completion, should the user choose to do so. A similar process would be followed for the above mentioned method of creating, managing, and adhering to a savings plan in which debt financing is used to purchase said item or group of items and then paid off by the application using funds provisioned by the user in said savings program.

In one or more embodiments, a user can use a piece of electronic hardware with a graphical user interface such as a computer, tablet, mobile device, or other piece of hardware with a graphical user interface to go to a website which collects the user's credit card and bank account information and, after receiving said information issues to said user a plastic card with a magnetic stripe that functions in a manner consistent with common understandings of a credit or debit plastic payment card. When said user swipes said card in any payment location for any particular goods or services, or enters the card number and any other pertinent payment information contained on the card in exchange for goods or services, the user's checking account is debited in an amount equal to price of the goods or services purchased. The funds debited from said checking account are held in trust by a third party application, which also manages said website, and at the moment of payment funds from said user's credit card are used to purchase said goods or services. After an interval of time predetermined by the user, said provisioned funds are used to pay off the credit card debt on behalf of said user, thereby eliminating the need and the associated inconvenience and burden to said user of having to pay off said credit card debt, thereby eliminating the risk of repayment to the user and associated excessive interest rate charges. Said plastic card would effectively be an integrated credit and debit card, to the extent that it has features of both credit and debit cards.

In one or more embodiments, an electronic hardware-based system of easily and conveniently provisioning or saving money for a particular item or group of items by a user is observed. Said system is flexible in that users can direct funds as they wish into, out of, and between plans with ease, may change the particular item or group of items saved for, and said system has a means of connecting to payment information of the user. Said system may house funds either in the user's bank accounts or in accounts proprietary to a third party. Said system may be hosted on an application retail store or a merchant, vendor, or retailer's store, be it a physical store or an online store.

In one or more embodiments, a user can utilize said method of automatically saving for a particular item or group of items to save up for a down payment on property such as a home (such as a standalone house, condominium, apartment, townhouse, or other residence), automobile, or other property and after completing such down payment saving process, use the proceeds from said process to provide a down payment to a bank, credit union, or other creditor that may require such a down payment on behalf of the borrower. For example, in one or more embodiments, a user could, using an electronic hardware-based network and a graphical user interface, peruse homes in a particular neighborhood and price range, select one or several potential homes within the user's budget and desired location or simply select an overall budget and price range, and then use said method to save up automatically for a certain percentage of the overall price of said home or budget, said percentage to be applied as a down payment on a loan to purchase said property in the future. For example, an application which hosts and publishes an online directory of listings of residences or similar property, said method could be introduced to the user as a means of saving for down payment on a particular residence or style of residence and price range in a particular location or neighborhood, and initiated and managed from said application website or a third party website, such a merchant website. As new residences or similar property meeting the pre-determined criteria set forth by the user become available in said location or neighborhood and within said price range and other parameters pre-determined by said user, said application can send updates to the user to determine the continued suitability of said residence or other available property meeting said pre-determined parameters to said user. If suitable residences or property are no longer available to said user, user may use said application or third party website to peruse other alternatives that meet the user's pre-determined criteria. One or more similar embodiments can be available for other property such as automobiles, or expenses associated with intangible experiences such as international or domestic travel for business, personal, or other reasons. One or more similar embodiments may offer a user a complimentary method to select a means of financing the remaining balance of the purchase from a variety of options provided by a plethora of creditors, thereby coupling the down payment saving portion with the financed portion such that, together with the process of selecting and monitoring properties in a particular neighborhood and price range, the time and effort associated with saving up for a down payment for a home or other property, financing said home or other property, and purchasing said home or other property is substantially reduced.

Accordingly, the scope should be determined not by the embodiments illustrated, but by the appended claims and their legal equivalents.

At least one electronic-hardware based method of creating, managing, and adhering to a savings plan for a particular item or group of items that is integrated with a shopping experience has been presented.

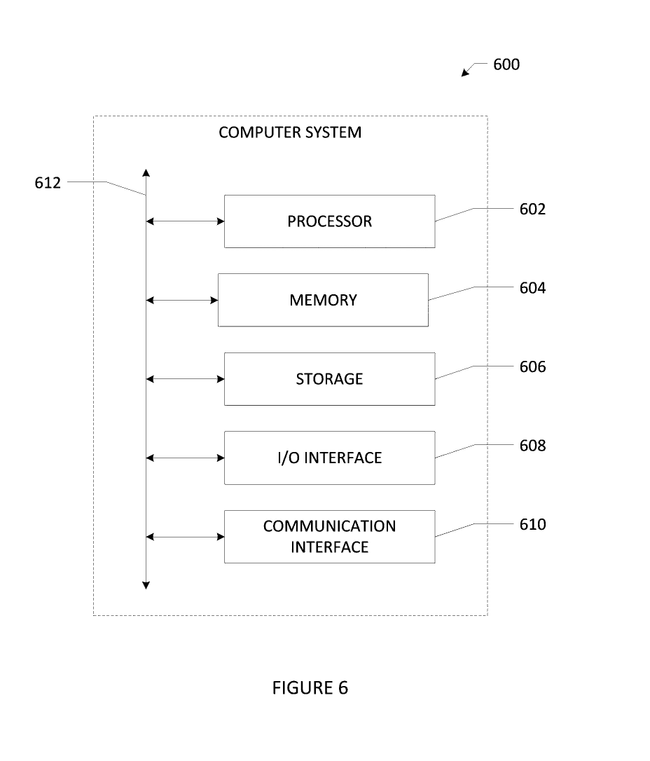

FIG. 6 illustrates an example computer system. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600.

The invention contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, an arcade console, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. The present invention contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. Processor 602 may include one or more arithmetic logic units (ALUs); be a multi-core processor; or include one or more processors 602.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 604 may include one or more memories 604, where appropriate.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, game controller, microphone, monitor, mouse, printer, scanner, speaker, still camera, stylus, tablet, touch screen, trackball, video camera, another suitable I/O device or a combination of two or more of these. An I/O device may include one or more sensors. Where appropriate, I/O interface 608 may include one or more device or software drivers enabling processor 602 to drive one or more of these I/O devices. I/O interface 608 may include one or more I/O interfaces 608, where appropriate.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This invention contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language. In particular embodiments, software is expressed in ruby-on-rails, Node.js, Python, Scala, or Unity.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A computer-implemented method for a user to save for an item or group of items to be purchased later, the computer-implemented method comprising:
accessing, by a user, an electronic hardware interface that includes software for creating, managing, and adhering to a savings plan to later purchase one or more items offered for sale by a retail store, to create the savings plan for the one or more items selected by the user;
customizing, by the user, the savings plan by the user specifying the amount, duration, and payment interval for later being able to purchase the one or more items, and the user associating payment information of the user;
activating and operating the savings plan, by the user, by making scheduled payments according to the savings plan; and
completing, by the user, the savings plan, resulting in the one or more items being purchased by the user.

2. A computer-implemented system for enabling a user to save for an item or group of items to be purchased later, the system comprising:
an electronic hardware interface that enables a user to access a saving method;
an electronic-readable storage medium that stores one or more inputs from the user;
a retail store comprising a retailer offering one or more items for sale to the user;
a means for the user to select the one or more items for sale;
a means for the user to create a savings plan for the one or more items selected by the user;
a means for connecting payment information of the user to the savings plan;
a means for activating and operating the savings plan through to completion; and
a means for the user to purchase the one or more items upon completion of the savings plan;
whereby the user shopping at the retail store utilizes the savings plan to substantially improve a financial outcome of the user, whereby the retail store has visibility into the one or more items selected by the user as an indication of consumer demand.

3. The system of claim 2, further comprising a means for customizing the savings plan.

4. The system of claim 2, further comprising a means for reviewing details of the savings plan.

5. The system of claim 2, further comprising a savings account for gathering funds saved according to the savings plan.

6. The system of claim 2, further comprising a means for monitoring the savings plan.

7. The system of claim 6, wherein the means for monitoring the savings plan comprises a graphical user interface accessible by the user where the user tracks progress of the savings plan.

8. The system of claim 6, wherein the means for monitoring the savings plan comprises a tracking system enabling one or more third parties to monitor the savings plan of the user or other savings plans of another user.

9. The system of claim 2, further comprising a means for the user to obtain the one or more items purchased upon completion of the savings plan.

10. The system of claim 2, wherein the means for activating and operating the savings plan comprises an electronic payment system accessible over a network.

11. The system of claim 10, wherein the electronic payment system is operated by a creditor.

12. The system of claim 11, wherein the creditor is a bank.

13. The system of claim 2, wherein the electronic hardware interface is one of a computer, tablet, and mobile device.

14. The system of claim 2, wherein the electronic-readable storage medium is a third party data storage hardware device accessible over a network.

15. The system of claim 2, wherein the retail store is an electronic retail storefront that is accessible over a network.

16. The system of claim 15, wherein the electronic retail storefront is a third party vendor.

17. The system of claim 2, further comprising a means for the retail store to select and control which of the one or more items are offered for sale through the savings plan.

18. The system of claim 2, further comprising a means for the retail store to limit a total time that the user has to complete the savings plan.

19. The system of claim 2, wherein the savings plan includes an option for debt financing by a creditor.

20. The system of claim 19, wherein upon completion of the savings plan the creditor is paid an amount saved.
